(19) United States
(12) Patent Application Publication
(10) Pub. No.: US 2022/0275221 A1
(43) Pub. Date: Sep. 1, 2022

(54) METHOD FOR REMOVING INK OR OTHER FOREIGN MATERIALS FROM THE SURFACE OF AN ARTICLE

(71) Applicant: Borealis AG, Vienna (AT)

(72) Inventors: Simon Anthony Jones, Vienna (AT); Rebeca Reguillo Carmona, Linz (AT); Kilian Piettre, Linz (AT); Sameer Vijay, Linz (AT); David Ganglberger, Linz (AT)

(21) Appl. No.: 17/629,112

(22) PCT Filed: Jul. 16, 2020
(86) PCT No.: PCT/EP2020/070086

§ 371 Date: Jan. 21, 2022

(30) Foreign Application Priority Data
Jul. 26, 2019 (EP) 19188618.3

(51) Int. Cl. C09D 9/00

(52) U.S. Cl. CPC C09D 9/00

(57) ABSTRACT

A method for removing ink and/or a foreign material different from ink from the surface of an article, wherein at least a part of the surface of the article comprises a polymer, the method includes: i) providing an ink imprinted article and/or an article having a surface covered at least partly by a foreign material different from ink; ii) contacting the article provided in step i) with an acid having a pKa in the range from −10 to 7 having a minimum concentration of 1 wt.-% for solving the ink and/or the foreign material different from ink or their degradation products in the acid; iii) separating the acid and the therein dissolved ink- and/or foreign material different from ink or their degradation products from the article to obtain a deinked article and/or an article with a surface free from foreign material.

### CROSS REFERENCE TO RELATED APPLICATION(S)

The present application is a national stage entry under 35 U.S.C. § 371 of International Application No. PCT/EP2020/070086 filed on Jul. 16, 2020, which claims priority to European Application No. 19188618.3 filed on Jul. 26, 2019, the entire contents of which are incorporated in their entirety.

### FIELD OF THE INVENTION

The present invention relates to a method for removing ink and/or a foreign material different from ink from the surface of an article. Furthermore, the present invention relates to the use of said method for the recycling of polymers.

### BACKGROUND

From the prior art some methods for removing ink from plastic materials are already known.

EP 2 832 459 A1 relates to a method for removing ink printed on a plastic film comprising various physical/chemical treatments. The main steps in the method are: conditioning the material, grinding, removing ink from the film, washing the film, recovering the cleaning solution, recovering the pigment and drying the film. As a result of the method, it is possible to obtain, on one hand, a plastic film free of ink and, on the other hand, the pigment.

WO 2012/151291 A2 refers to an apparatus and a method for removing an ink image from a plastic substrate, particularly a plastic container such as a cup. A solvent capable of solvating the ink image is utilized in order to de-ink articles so that they can be recycled and re-imprinted thereby reducing waste associated with printing line start up.

The methods known from the prior art for removing ink from a substrate refer to the use of a combination of several components comprising alcohols, anionic and cationic surfactants and solvents.

These methods have some disadvantages. The deinking efficiency is a direct consequence of the concentration of the components used in the deinking mixture and deviations in the mixture affect the efficiency of deinking. Furthermore, due to the requirement of a specific combination of components, the complexity of the process increases when these solutions are intended for reuse in the process after cleaning. In addition, the deinking mixtures known from the prior art are quite expensive and the processes have to be conducted at elevated temperatures.

### SUMMARY OF THE INVENTION

It was therefore an objective of the present invention to provide a method that allows the use of a single component for removing ink from the surface of an article. The advantages of using a single component solution include reduced complexity resulting in a lower price and increased reusability of the deinking solution mix without requiring concentration measurement and suitable top-up. In addition, it was an objective of the present invention to provide a method, which is not only suitable for removing ink from the surface of an article, but which also allows to remove foreign materials different from ink. Furthermore, it was an objective of the present invention to provide a method that neutralizes odor, which is particularly preferable when the article is a waste material. In addition, it was an object of the present invention to provide a method which is not limited with regard to the articles used, that works for example for flakes, films and chips but also for more complex packaging structures. Another objective of the present invention was the provision of a process which allows an efficient sorting of the final products, for example by color or polymer type.

These objectives have been solved by a method for removing ink and/or a foreign material different from ink from the surface of an article, wherein at least a part of the surface of the article comprises a polymer selected from the group consisting of polyolefins, polystyrene, melamine polymers, polyvinyl chloride, polyethylene terephthalate, polyamides and mixtures thereof, the method comprises the following steps:
i) providing an ink imprinted article and/or an article having a surface covered at least partly by a foreign material different from ink;
ii) contacting the article provided in step i) with an acid having a pKa in the range from −10 to 7 having a minimum concentration of 1 wt.-% for solving the ink and/or the foreign material different from ink or their degradation products in the acid;
iii) separating the acid and the therein dissolved ink- and/or foreign material different from ink or their degradation products from the article to obtain a deinked article and/or an article with a surface free from foreign material.

Advantageous embodiments of the method in accordance with the present invention are also specified.

The present invention further relates to the use of the method for the recycling of polymers and a preferred embodiment of the use according to the present invention.

### BRIEF DESCRIPTION OF THE DRAWINGS

FIG. 1 is a spectrum illustrating an analysed sample according to an embodiment of the present disclosure;

FIG. 2 represents examples of washes and the effect on inked samples represented in a CIELAB color space;

FIG. 3 is an image of LDPE-bags imprinted with blue, green and red ink and paper labels fixed with glue, commercially available from Borealis;

FIG. 4 illustrates images of commercial inks printed on PP and PE that were tested in the examples;

FIG. 5 illustrates images of food packaging samples that were tested in the examples;

FIG. 6 illustrates images of aseptic packaging that were tested in the examples;

FIG. 7 is a flexible PE/PA multiayer plastic packaging and adhesive paper, bought in a supermarket.

### DETAILED DESCRIPTION OF THE PRESENT INVENTION

### Definitions

For the purposes of the present description and of the subsequent claims, the term “acid” means the aqueous solutions of the “acid” or the pure “acid”. This means the “acid” may contain water and preferably contains waters. An “acid” is a substance that acts as a proton donor in aqueous solutions.

The acid may be monoprotic or multiprotic or a mixture thereof. In the gist of the present invention for multiprotic acids the “pKa” (logarithmic acid dissociation constant) refers to the first dissociation step of the acid.

In the spirit of the present invention an ink is a liquid or paste that comprises inorganic or organic pigments or dyes and a solvent. The ink may additionally comprise resins, lubricants, solubilizers, surfactants, particulate matter, fluorescents, and other materials.

The “article” according to the present invention can be in any form, including flakes, films and chips but also more complex packaging structures.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

### Method

In the following preferred embodiments of the method according to the present invention will be discussed.

In the broadest sense, the present invention relates to a method for removing ink and/or a foreign material different from ink from the surface of an article, wherein at least a part of the surface of the article comprises a polymer selected from the group consisting of polyolefins, polystyrene, melamine polymers, polyvinyl chloride, polyethylene terephthalate, polyamides and mixtures thereof, the method comprises the following steps:
i) providing an ink imprinted article and/or an article having a surface covered at least partly by a foreign material different from ink;
ii) contacting the article provided in step i) with an acid having a pKa in the range from −10 to 7 having a minimum concentration of 1 wt.-% and/or an amphoter for solving the ink and/or the foreign material different from ink or their degradation products in the acid and/or the amphoter;
iii) separating the acid and/or the amphoter and the therein dissolved ink- and/or foreign material different from ink or their degradation products from the article to obtain a deinked article and/or an article with a surface free from foreign material.

It is preferred that the method for removing ink and/or a foreign material different from ink from the surface of an article, wherein at least a part of the surface of the article comprises a polymer selected from the group consisting of polyolefins, polystyrene, melamine polymers, polyvinyl chloride, polyethylene terephthalate, polyamides and mixtures thereof, comprises the following steps:
i) providing an ink imprinted article and/or an article having a surface covered at least partly by a foreign material different from ink;
ii) contacting the article provided in step i) with an acid having a pKa in the range from −10 to 7 having a minimum concentration of 1 wt.-% for solving the ink and/or the foreign material different from ink or their degradation products in the acid;
iii) separating the acid and the therein dissolved ink- and/or foreign material different from ink or their degradation products from the article to obtain a deinked article and/or an article with a surface free from foreign material.

In an alternative embodiment, the method for removing ink and/or a foreign material different from ink from the surface of an article, wherein at least a part of the surface of the article comprises a polymer selected from the group consisting of polyolefins, polystyrene, melamine polymers, polyvinyl chloride, polyethylene terephthalate, polyamides and mixtures thereof, comprises the following steps:
i) providing an ink imprinted article and/or an article having a surface covered at least partly by a foreign material different from ink;
ii) contacting the article provided in step i) with an amphoter for solving the ink and/or the foreign material different from ink or their degradation products in the amphoter;
iii) separating the amphoter and the therein dissolved ink- and/or foreign material different from ink or their degradation products from the article to obtain a deinked article and/or an article with a surface free from foreign material.

In principle, the invention can be carried out for any foreign material which is soluble in the acids or the amphoter as applied in step ii) of the method according to the present invention.

According to one preferred embodiment according to the present invention the foreign material different from ink is selected from the group consisting of labels, preferably made of paper, mono- or multilayer films, organic coatings, inorganic coatings, preferably vapour deposed metallic materials and non-metallic materials or aluminium, adhesives, glues, metals, organic waste, non-organic waste, odorous materials and mixtures thereof. The method also works when the surface of the article comprise ink and a foreign material different from ink.

The method can also be conducted for multi-layered articles and the foreign material may form a separate layer. In a preferred embodiment, the method is used for separating multi-layered articles.

Another preferred embodiment of the present invention stipulates that the acid is selected from the group consisting of oleum, sulphuric acid, phosphoric acid, nitric acid, hydrochloric acid, hydrofluoric acid, boric acid, adipic acid, formic acid, acetic acids, and mixtures thereof and preferably is sulphuric acid.

In principle, the invention can be carried out for articles being resistant against the acids as applied in step ii) of the method according to the present invention. In a preferred embodiment the surface of the article consists of the polymer, and preferably the whole article consists of the polymer; and/or the polymer is a polyolefin, preferably polyethylene and/or polypropylene or polyamide, preferably PA 6 and/or PA 66 or mixtures thereof.

According to a further preferred embodiment of the present invention at least a part of the surface of the article comprises a material selected from the group consisting of glass, ceramics, steel and mixtures thereof.

Another preferred embodiment of the present invention stipulates that the acid has a concentration in the range from 10 to 100 wt.-% (corresponds for sulphuric acid to a molarity of 1.8 M to 18.65 M), preferably from 45 to 98 wt.-% (corresponds for sulphuric acid to a molarity of 6.2 M to 18.4 M) and more preferably is sulphuric acid having a concentration of 94 to 98 wt.-% .-% (corresponds to a molarity of 17.8 M to 18.4 M), more preferably having a concentration of 96 wt.-% (corresponds to a molarity of 18.4 M).

In another preferred embodiment of the present invention, the pKa of the acid is in the range from −5 to 5 and preferably from −5 to 0.

According to still a further preferred embodiment of the present invention the minimum concentration of the acid is 10 wt.-% and preferably is 25 wt.-%.

The invention can be carried out by applying more than one acid in step ii). The above-mentioned concentration and pKa-values refer to each individual acid.

A further embodiment of the present invention stipulates that sulphuric acid having preferably a concentration of 94 to 98 wt.-% is used as sole acid during step ii). As explained above the acid may be an aqueous solution, this means that the acid may contain water.

According to still another preferred embodiment of the present invention the article is not contacted with a compound selected from the group consisting of organic solvents, surfactants, alcohols and mixtures thereof during step ii). In other words, the article is contacted only with the acid, which may be an aqueous solution.

Another preferred embodiment of the present invention stipulates that the method comprises an additional step iv) of rinsing residual ink- and/or foreign material residues and/or degradation products thereof from the article which is carried out after step ii).

In a further preferred embodiment of the present invention, the method is conducted continuously and the acid obtained after separation step (iii) is reintroduced into contacting step (ii).

According to another preferred embodiment of the present invention, the mixture of acid and article's surface is subjected to sheer forces induced by a mechanical mixing, preferably by agitation, pump-around loop, mechanical grinding, extrusion, addition of abrasive agents and/or treated with ultrasonic during step ii).

A further preferred embodiment of the present invention stipulates that step iii) is conducted by a separation method selected from the group consisting of methods using the density difference between the materials to be separated, methods using the gravity and mechanical methods.

According to a further preferred embodiment of the present invention step ii) is conducted at a temperature in the range from −86° C. to 500° C., preferably in the range from 20 to 100° C. and more preferably in the range from 20 to 70° C. and more preferably at 40° C. The freezing point of pure sulphuric acid is 10° C., but for mixtures of sulphuric acid and water the freezing point can go as low as −86° C. Hence, it is basically possible to conduct the process at very low temperatures.

Still another preferred embodiment of the present invention stipulates that step ii) is conducted for a period of time from 1 to 600 minutes, preferably in the range from 1 to 15 minutes and more preferably in the range from 1 to 10 minutes.

In a further preferred embodiment of the present invention step ii) is conducted with 96 wt.-% sulphuric acid at a temperature in the range from 20 to 70° C., preferably from 20 to 40° C. and more preferably for a period of time in the range from 1 to 600 min, 1 to 15 minutes, most preferably from 1 to 10 minutes.

It is believed that the removal of the ink and/or the foreign material follows the Arrhenius equation, which means that increasing of the temperature allows to shorten the process time for step ii) and decreasing the temperatures leads to a prolonged process time for step ii). It is also assumed that the process time for step ii) is highly dependent on the concentration of the acid, the removal of the ink and/or the foreign material occurs faster when applying an acid having a higher concentration than when an acid with a lower concentration is used.

The process may be conducted under increased pressure, which makes it possible to work at higher temperatures, i.e. temperatures above the boiling point of the acid under standard pressure (1013 mbar).

Some preferred combinations for the parameters determining the period of time for step ii) are listed below.

Material to be removed: ink and/or foreign material

Temperature: 25 to 40° C.

Acid: sulphuric acid

Concentration of the acid: 70 to 100 wt.-%, preferably 70 to 98 wt.-%

Period of time for step ii): 1 to 10 minutes

Material to be removed: ink and/or foreign material

Temperature: 40 to 100° C.

Acid: sulphuric acid

Concentration of the acid: 70 to 100 wt.-%, preferably 70 to 98 wt.-%

Period of time for step ii): 1 to 10 minutes

Material to be removed: ink and/or foreign material

Temperature: 25 to 40° C.

Acid: sulphuric acid

Concentration of the acid: 45 to 70 wt.-%

Period of time for step ii): 1 to 60 minutes

Material to be removed: ink and/or foreign material

Temperature: 40 to 100° C.

Acid: sulphuric acid

Concentration of the acid: 45 to 70 wt.-%

Period of time for step ii): 1 to 60 minutes

According to another preferred embodiment of the present invention, the article is not decomposed or attacked during step ii). In this context, “not decomposed” means that the acid treatment does not impact the re-use of the article, preferably in a subsequent recycling process.

### Use

The present invention also relates to the use of the method as defined above for the recycling of polymers.

In a preferred embodiment, the polymer originates from post-consumer waste or post-industrial waste, post-commercial waste and preferably is a rigid or flexible material.

Such post-consumer, post-commercial, and/or post-industrial waste can be derived from inter alia waste electrical and electronic equipment (WEEE) or end-of-life vehicles (ELV) or from differentiated waste collection schemes like the German DSD system, the Austrian ARA system or the Italian “Raccolta Differenziata” system.

Recycled materials are commercially available, e.g. from Corpela (Italian Consortium for the collection, recovery, recycling of packaging plastic wastes), Resource Plastics Corp. (Brampton, ON), Kruschitz GmbH, Plastics and Recycling (AT), Ecoplast (AT), Vogt Plastik GmbH (DE), mtm plastics GmbH (DE) etc.

The invention will now be described with reference to the following non-limiting examples.

### Experimental Part

### A. Measuring Methods

### Infrared Spectroscopy

The IR analysis was done on a Diamond—ATR called “Golden Gate” from manufacturer Specac. The sample was pressed on the crystal with spring pressure 3 by the pressure plate. The HATR (horizontal attenuated total reflectance) spectrum should be acquired under following instrument conditions, as summarized in below Table 1.

TABLE 1
Conditions for IR analysis.

| Spectral range | 4000 to 600 | cm⁻¹ |
|---|---|---|
| Aperture | 6 | mm |
| Spectral resolution | 4 | cm⁻¹ |

| | |
|---|---|
| Number of background scans | 25 |
| Number of spectrum scans | 25 |
| Interferogram zero-filling factor | 32 |
| Apodisation function | Norton Beer strong |

The obtained spectrum shall be checked as for its bands' position and bands' intensity, and shall be compared with a standard spectrum. If it concerns unknown spectra, the library software shall be used.

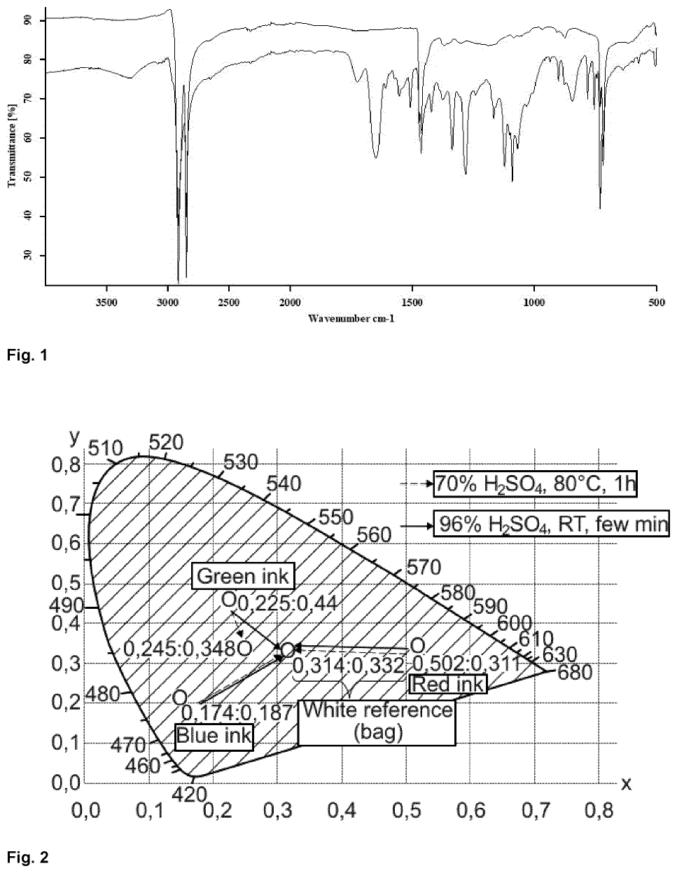

An example of an analysed sample and its respective spectrum is shown in FIG. 1. In FIG. 1, the lower spectrum represents the sample and the upper spectrum represents the washed sample. The upper spectrum corresponds to that of the LDPE without ink.

### Colorimetry

The colorimetry data was captured with a Spectrophotometer ColorLite sph850, a colour-measuring instrument suitable for a wide range of applications and the ColorData software. The reference used was the plastic bag without any ink. The detector was placed upon the film and the measurement was made with three repetitions. The values were recorded directly on the computer. FIG. 2 shows some examples of washes and the effect on inked samples that represented in a CIELAB color space. In FIG. 2, the CIELAB color codes for the red, blue, green and white reference are labelled. The white reference is used to compare the samples after the washing step. The washed sample should present the same color codes as the white reference. The arrows represents different washing conditions that were applied on the ink samples: dark for 70 wt.-% H₂SO₄ at 80° C. for 1 h and grey for 96 wt.-% H₂SO₄ at room temperature for few minutes. From FIG. 2, it can be seen that all grey arrows lead to the white reference, while only the green ink could not be fully washed with the dark arrow conditions.

### B. Materials Used

### LDPE-Bags

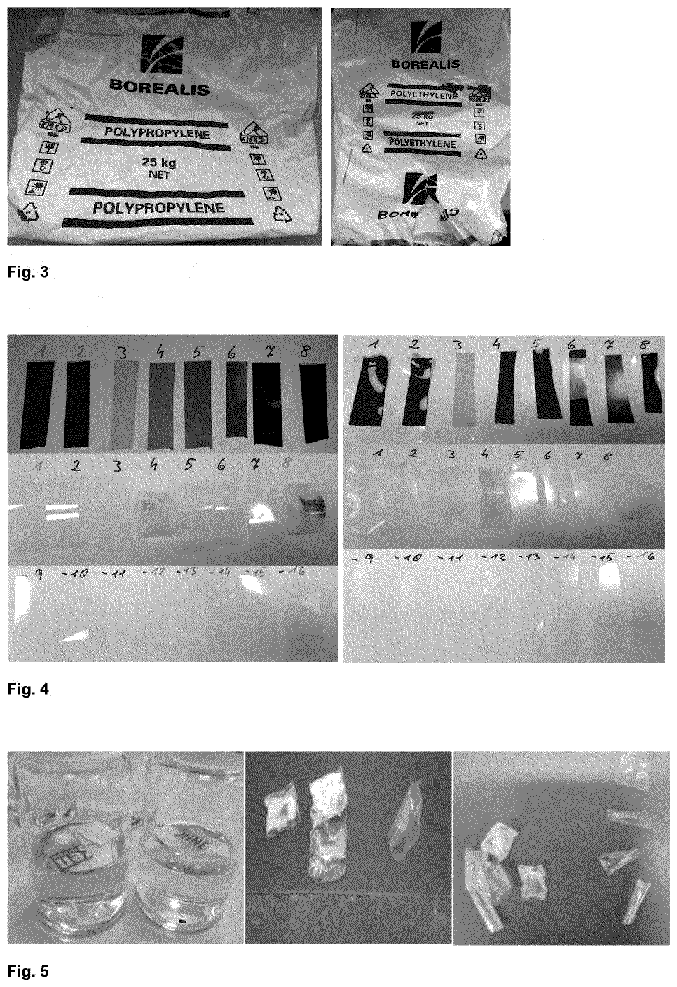

LDPE-bags imprinted with blue, green and red ink and paper labels fixed with glue, commercially available from Borealis (see FIG. 3).

H₂SO₄

H₂SO₄ (96 commercially available from Sigma Aldrich Corporation), H₂SO₄ having a lower concentration was obtained by dilution with distilled water.

### Commercial Ink

Inks containing eight different pigments and binded with nitrocellulose, commercially available from Siegwerk.

### PE-Film

PE film of 30 μm thickness, commercially available Mondi.

### PP-Film

Oriented PP film of 30 μm thickness, commercially available from Mondi.

### Food-Packaging and Adhesive Paper

Flexible PE/PA multilayer plastic packaging and adhesive paper, bought in a supermarket (see FIG. 7).

### Multilayer Package

Multilayer package used for milk available from Elopak (Roll Feed).

### C. Deinking Trials

LDPE-bags as described above printed with ink were cut into pieces and treated with sulphuric acid at different concentrations and temperatures. The desired concentration of sulphuric acid was added to a vial with a magnetic stirrer and the pieces of bags were dipped in the vial. The medium was stirred (and heated at the desired temperature if necessary) for the desired amount of time. Table 2 summarizes the results.

TABLE 2
Summary of deinking test on LDPE-bags.

| | Conc. | | | | |
|---|---|---|---|---|---|
| | H₂SO₄ | Temp. | Time | | |
| No. | [wt.-%] | [° C.] | [minutes] | Ink | Visual evaluation |
| 1 | 45 | 80 | 60 | Blue ink | No big differences |
| | | | | Red ink | No big differences |
| | | | | Green ink | No big differences |
| 2 | 45 | 80 | 240 | Blue ink | Blue ink removed |
| | | | | Red ink | Red ink partially |
| | | | | Green ink | removed, |
| | | | | | Green ink only small |
| | | | | | amounts removed |
| 3 | 70 | 80 | 60 | Blue ink | Blue ink removed |
| | | | | Red ink | Red ink removed |
| | | | | Green ink | Green ink partially |
| | | | | | removed |
| 4 | 70 | 80 | 240 | Blue ink | Blue ink removed |
| | | | | Red ink | Red ink removed |
| | | | | Green ink | More green ink |
| | | | | | removed than |
| | | | | | after 60 minutes |
| 5 | 96 | 21 | 2 | Blue ink | Blue ink traces present |
| | | | | Red ink | Red ink removed |
| | | | | Green ink | Green ink removed |
| 6 | 96 | 21 | 8 | Blue ink | Blue ink removed |
| | | | | Red ink | Red ink removed |
| | | | | Green ink | Green ink removed |

The visual evaluation according to Table 1 was verified by using infrared spectroscopy and colorimetry (see FIG. 1 and FIG. 2). The deinked materials contained no acid effect or ink degradation products, thus resulting in high quality of the cleaned material without any ink residues. The ink residues stay with the acid solution and are removable by distillation or adsorbent media.

Trials on commercial inks printed on PP (FIG. 4, left) and PE (FIG. 4, right) were performed as well. The films were cut into pieces and treated with sulphuric acid at different concentrations and temperatures. The desired concentration of sulphuric acid was added to a vial with a magnetic stirrer and the pieces of the films were dipped in the vial. The medium was stirred (and heated at the desired temperature if necessary) for the desired amount of time. The results are summarized in below Table 3.

TABLE 3
Summary of deinking test on PP and PE films.

| | Conc. | | | | |
|---|---|---|---|---|---|
| | H₂SO₄ | Temp. | Time | Ink (No. in | |
| Film | [wt.-%] | [° C.] | [min.] | FIG. 4) | Visual evaluation |
| PP | 70 | RT to | 5 to 10 | Blue ink 1 (1) | No ink remaining |
| | | 40 | | Blue ink 2 (2) | No ink remaining |
| | | | | Yellow ink (3) | Little ink remaining |
| | | | | Green ink (4) | Some ink remaining |
| | | | | Red ink 1 (5) | No ink remaining |
| | | | | Red ink 2 (6) | No ink remaining |
| | | | | Purple ink (7) | No big differences |
| | | | | Black ink (8) | Some ink remaining |
| PP | 96 | RT | 5 | Blue ink 1 (1) | No ink remaining |
| | | | | Blue ink 2 (2) | No ink remaining |
| | | | | Yellow ink (3) | No ink remaining |
| | | | | Green ink (4) | No ink remaining |
| | | | | Red ink 1 (5) | No ink remaining |
| | | | | Red ink 2 (6) | No ink remaining |
| | | | | Purple ink (7) | No ink remaining |
| | | | | Black ink (8) | No ink remaining |
| PE | 70 | RT to | 5 to 10 | Blue ink 1 (1) | No ink remaining |
| | | 40 | | Blue ink 2 (2) | No ink remaining |
| | | | | Yellow ink (3) | Little ink remaining |
| | | | | Green ink (4) | Some ink remaining |
| | | | | Red ink 1 (5) | No ink remaining |
| | | | | Red ink 2 (6) | No ink remaining |
| | | | | Purple ink (7) | No big differences |
| | | | | Black ink (8) | Little ink remaining |
| PE | 96 | RT | 5 | Blue ink 1 (1) | No ink remaining |
| | | | | Blue ink 2 (2) | No ink remaining |
| | | | | Yellow ink (3) | No ink remaining |
| | | | | Green ink (4) | No ink remaining |
| | | | | Red ink 1 (5) | No ink remaining |
| | | | | Red ink 2 (6) | No ink remaining |
| | | | | Purple ink (7) | No ink remaining |
| | | | | Black ink (8) | No ink remaining |

RT = room temperature

### D. Removal of Paper Tests

Trials on LDPE-bags with adhesive paper were also conducted. The bags were cut into pieces and treated with sulphuric acid at different concentrations and temperatures. The desired concentration of sulphuric acid was added to a vial with a magnetic stirrer and the pieces of the LDPE bags were dipped in the vial. The medium was stirred (and heated at the desired temperature if necessary) for the desired amount of time. The results are summarized in below Table 4.

TABLE 4
Summary of adhesive paper removal test on LDPE-bags.

| | Conc. | | | | |
|---|---|---|---|---|---|
| | H₂SO₄ | Temp. | Time | Foreign | |
| Film | [wt.-%] | [° C.] | [min.] | material | Visual evaluation |
| PE | 96 | RT | 90 | Adhesive | No paper or adhesive |
| | | | | paper | remaining |
| PE | 96 | 40 | 20 | Adhesive | No paper or adhesive |
| | | | | paper | remaining |

Food packaging samples (FIG. 5) were also tested. The samples are a PP-film and inked with different colours. The samples were cut into pieces were dipped into a desired concentrated sulphuric acid solution and stirred at the desired temperature for the desired amount of time. Table 5 summarizes the results.

TABLE 5
Summary of deinking test on PP films from food packaging.

| | Conc. | | | Ink or | |
|---|---|---|---|---|---|
| | H₂SO₄ | Temp. | Time | foreign | |
| Film | [wt.-%] | [° C.] | [min.] | material | Visual evaluation |
| PP | 96 | RT | 45 | Colored ink | No ink remaining but |
| | | | | | white appearance of |
| | | | | | the film |
| PP | 96 | RT | 90 | Colored ink | No ink remaining and |
| | | | | | less white appearance |
| | | | | | of the film |
| PP | 96 | 40 | 45 | Colored ink | Little ink remaining |
| PP | 96 | 40 | 90 | Colored ink | No ink remaining |

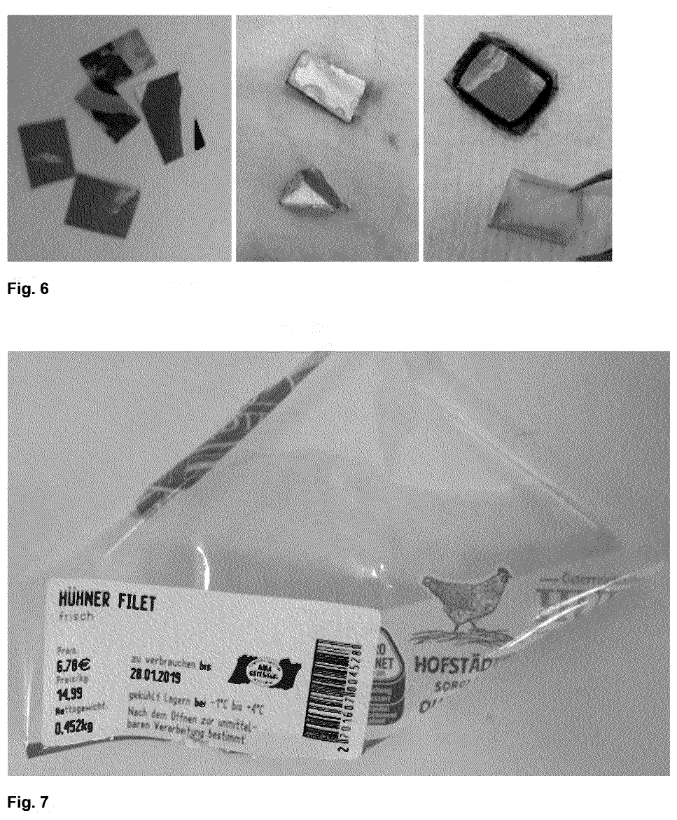

In addition a feasibility test on multi-layer packaging, for example aseptic packaging such as Milk package bricks (FIG. 6) was conducted. A commercially available milk package was used. As for the previous tests, the sample was cut into pieces and was dipped into a desired concentrated sulphuric acid solution and stirred at the desired temperature for the desired amount of time. Table 6 summarizes the results.

TABLE 6
Summary of delayering test on Milk package bricks.

| | Conc. | | | | |
|---|---|---|---|---|---|
| | H₂SO₄ | Temp. | Time | Foreign | |
| Film | [wt.-%] | [° C.] | [minutes] | material | Visual evaluation |
| Elopak | 96 | RT | 180 | Multilayer | No big differences |
| Elopak | 96 | RT | 1200 | Multilayer | Outer layer clean |
| Elopak | 96 | 40 | 180 | Multilayer | Layers are detached |
| Elopak | 96 | 40 | 1200 | Multilayer | Layers are detached |
| | | | | | and film deinked |

1. A method for removing ink and/or a foreign material different from ink from the surface of an article, wherein at least a part of the surface of the article comprises a polymer selected from the group consisting of polyolefins, polystyrene, melamine polymers, polyvinyl chloride, polyethylene terephthalate, polyamides and mixtures thereof, the method comprises the following steps:
i) providing an ink imprinted article and/or an article having a surface covered at least partly by a foreign material different from ink;
ii) contacting the article provided in step i) with an acid having a pKa in the range from −10 to 7 having a minimum concentration of 1 wt.-% for solving the ink and/or the foreign material different from ink or their degradation products in the acid;
iii) separating the acid and the therein dissolved ink- and/or foreign material different from ink or their degradation products from the article to obtain a deinked article and/or an article with a surface free from foreign material.

2. The method according to claim 1,
wherein the foreign material different from ink is selected from the group consisting of labels, paper, mono- or multilayer films, organic coatings, inorganic coatings, vapour deposed metallic materials and non-metallic materials or aluminium, adhesives, glues, metals, organic waste, non-organic waste, odorous materials and mixtures thereof.

3. The method according to claim 1,
wherein the acid is selected from the group consisting of oleum, sulphuric acid, phosphoric acid, nitric acid, hydrochloric acid, hydrofluoric acid, boric acid, adipic acid, formic acid, acetic acids, and mixtures thereof.

4. The method according to claim 1,
wherein the surface of the article consists of the polymer, and preferably the whole article consists of the polymer; and/or
the polymer is a polyolefin.

5. The method according to claim 1,
wherein the acid has a concentration in the range from 45 to 98 wt. %; and/or
the pKa of the acid is in the range from −5 to 5; and/or
the minimum concentration of the acid is 10 wt. %.

6. The method according to claim 1,
wherein sulphuric acid having preferably a concentration of 94 to 100 wt. % is used as sole acid during step ii).

7. The method according to claim 1,
wherein the article is not contacted with a compound selected from the group consisting of organic solvents, surfactants, alcohols and mixtures thereof during step ii).

8. The method according to claim 1,
wherein the method comprises an additional step iv) of rinsing residual ink- and/or foreign material residues and/or degradation products thereof from the article which is carried out after step ii).

9. The method according to claim 1,
wherein the method is conducted continuously and the acid obtained after separation step (iii) is reintroduced into contacting step (ii).

10. The method according to claim 1,
wherein the mixture of acid and article's surface is subjected to sheer forces induced by a mechanical mixing, addition of abrasive agents and/or treated with ultrasonic during step ii); and/or
step iii) is conducted by a separation method selected from the group consisting of methods using the density difference between the materials to be separated, methods using the gravity and mechanical methods.

11. The method according to claim 1,
wherein step ii) and/or step iii) is conducted at a temperature in the range from 20 to 100° C.; and/or
step ii) and/or step iii) is conducted for a period of time from 1 to 15 minutes.

12. The method according to claim 1,
wherein step ii) is conducted with 96 wt.-% sulphuric acid at a temperature in the range from 20 to 70° C.

13. The method according to claim 1,
wherein the article is not decomposed or attacked during step ii).

14. The method according to claim 1, wherein the method is a constituent step in a method for the recycling of polymers.

15. The method according to claim 14, wherein the polymer originates from post-consumer waste, post-industrial waste, or post-commercial waste.

16. The method according to claim 1, wherein the acid is sulphuric acid.

17. The method according to claim 16, wherein the sulphuric acid has a concentration of 94 to 98 wt.-%.

18. The method according to claim 1, wherein the polymer is polyethylene and/or polypropylene, or polyamide.

19. The method according to claim 12, wherein step ii) is conducted for a period of time in the range from 1 to 15 minutes.
